(19) United States
(12) Patent Application Publication
(10) Pub. No.: US 2026/0177895 A1
(43) Pub. Date: Jun. 25, 2026

(54) IMAGE PICKUP APPARATUS

(71) Applicant: CANON KABUSHIKI KAISHA, Tokyo (JP)

(72) Inventor: AYUMU NEMOTO, Tokyo (JP)

(21) Appl. No.: 19/422,999

(22) Filed: Dec. 17, 2025

(30) Foreign Application Priority Data
Dec. 24, 2024 (JP) 2024-227717

(51) Int. Cl. G03B 17/56; G03B 17/12; G03B 17/55; G03B 29/00

(52) U.S. Cl. CPC G03B 17/563; G03B 17/12; G03B 17/55; G03B 17/566; G03B 29/00; G03B 2217/002; G03B 2217/007

(57) ABSTRACT

An image pickup apparatus includes a grip portion, an operation unit configured to instruct imaging, a first connector dedicated to audio input/output for inputting or outputting audio, and a second connector dedicated to audio input/output for inputting or outputting audio. The first connector and the second connector are disposed on a side surface on a side of the grip portion.

### BACKGROUND

### Field of the Technology

The aspect of the disclosure relates to one or more embodiments of an image pickup apparatus.

### Description of the Related Art

Conventionally, image pickup apparatuses having a plurality of external interface (IF) cable connectors for connection with external devices have been known. Japanese Patent Application Laid-Open No. 2018-84717 discloses an image pickup apparatus that includes a plurality of external I/F cable connectors near a grip portion that allows a user to grip the image pickup apparatus.

However, in the image pickup apparatus disclosed in Japanese Patent Application Laid-Open No. 2018-84717, in a case where the number of external I/F cable connectors increases, it becomes difficult to reduce the size of the image pickup apparatus without impairing operability thereof.

### SUMMARY

One or more embodiments of an image pickup apparatus according to one or more aspects of the disclosure may include a grip portion, an operation unit configured to instruct imaging, a first connector dedicated to audio input/output for inputting or outputting audio, and a second connector dedicated to audio input/output for inputting or outputting audio. The first connector and the second connector are disposed on a side surface on a side of the grip portion.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of an image pickup apparatus according to this embodiment.

FIGS. 2A and 2B are perspective views illustrating an external appearance of the image pickup apparatus according to this embodiment.

FIGS. 3A to 3D are side views of the image pickup apparatus according to this embodiment.

FIGS. 4A, 4B, and 4C are external views illustrating a part of the image pickup apparatus according to this embodiment.

FIG. 5 is an exploded perspective view illustrating a part of the image pickup apparatus according to this embodiment.

FIGS. 6A, 6B, and 6C explain a battery box unit according to this embodiment.

FIGS. 7A, 7B, and 7C explain the battery box unit according to this embodiment.

FIG. 8 is a perspective view of a heat dissipation functional component of the image pickup apparatus according to this embodiment.

### DESCRIPTION OF THE EMBODIMENTS

Referring now to the accompanying drawings, a detailed description will be given of embodiments according to the disclosure.

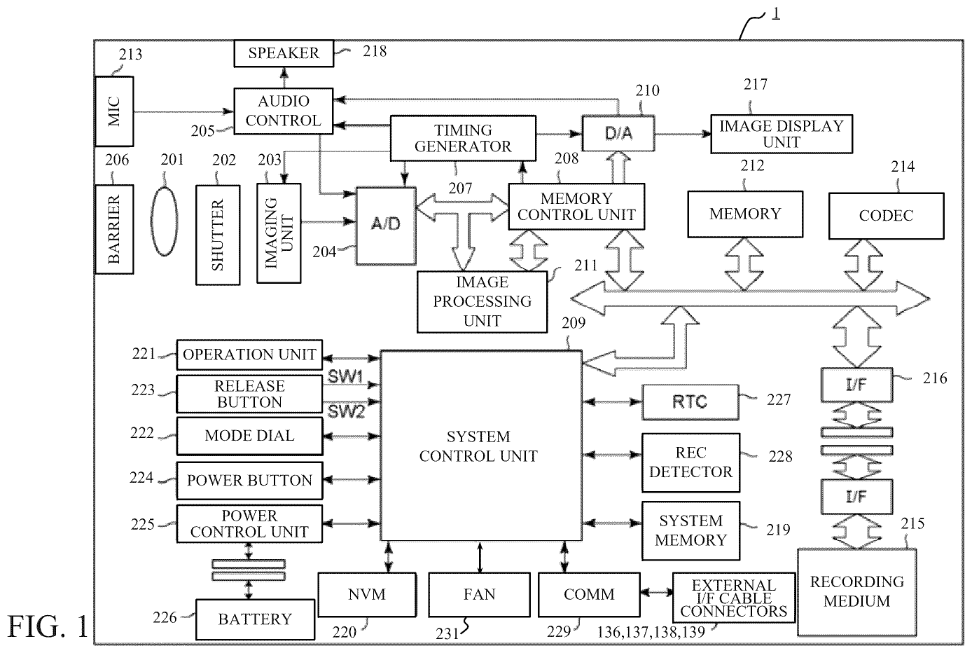

Referring now to FIG. 1, a description will be given of an image pickup apparatus 1 as an example of an electronic apparatus according to this embodiment (also referred to as a digital camera hereinafter).

In this embodiment, the image pickup apparatus 1 is configured as an image pickup apparatus with which an imaging optical system is integrated. However, this embodiment is not limited to this example, and is applicable to an image pickup system including a camera body having an image sensor, and an optical system (lens device) that is attachable to and detachable from the camera body.

First, an imaging unit in the image pickup apparatus 1 will be described. The imaging optical system in the imaging unit includes a lens 201 and a shutter 202 having an aperture stop function. An imaging unit 203 includes an image sensor, such as a CCD sensor or a CMOS sensor, which converts (photoelectrically converts) an optical image formed by the optical system into an electrical signal.

An A/D converter 204 is used to convert an analog signal output from the imaging unit 203 into a digital signal, or to convert an analog signal output from an audio control unit 205 into a digital signal. A lens barrier 206 covers the lens 201 and the imaging unit 203 of the image pickup apparatus 1 to protect them from contamination and damage. A timing generator 207 is controlled by a memory control unit 208 and a system control unit 209, and supplies a clock signal and a control signal to the imaging unit 203, the audio control unit 205, the A/D converter 204, and a D/A converter 210.

An image processing unit 211 performs image processing such as predetermined pixel interpolation, resizing (including reduction), and color conversion on output data from the A/D converter 204 and on data stored in a memory 212. The image processing unit 211 also performs predetermined calculations on image data obtained by imaging, and based on the obtained calculation result, the system control unit 209 performs exposure control and distance measurement control (focus detection processing). Through these operations, Through The Lens (TTL) type autofocus (AF), auto-exposure (AE), and pre-flash emission (EF) processing are performed. In addition, the image processing unit 211 performs predetermined calculations using the captured image data, and based on the calculation result, performs TTL auto white balance (AWB) processing.

Output data from the A/D converter 204 is written into the memory 212 via the image processing unit 211 and the memory control unit 208, or directly via the memory control unit 208. The memory 212 stores audio data recorded by a microphone 213, still or moving images captured, and information accompanying the images such as file headers that constitute image files. The memory 212 has a sufficient storage capacity to store a predetermined number of still images and/or a moving image and audio for a predetermined duration.

A compression/decompression unit (CODEC) 214 compresses and decompresses image data by adaptive discrete cosine transform (ADCT) or the like. That is, the CODEC 214 reads a captured image stored in the memory 212 in response to a trigger from the shutter 202, performs compression processing thereon, and writes the processed data into the memory 212. The CODEC 214 also reads compressed images stored in a recording medium 215 or the like into the memory 212, performs decompression processing, and writes the processed data into the memory 212.

The image data written in the memory 212 by the CODEC 214 is converted into a file by a file processing unit of the system control unit 209, and recorded on the recording medium 215 through a recording medium interface (recording medium I/F) 216. The above describes the imaging unit.

The memory 212 also functions as a memory for image display. Image data for display written into the memory 212 is displayed by an image display unit 217 through the D/A converter 210. An audio signal output from the microphone 213 is converted into a digital signal by the A/D converter 204 via the audio control unit 205, which includes an amplifier and the like, and stored in the memory 212 by the memory control unit 208. On the other hand, audio data recorded in the recording medium 215 is read into the memory 212, processed by the audio control unit 205 via the D/A converter 210, and output as sound through a speaker 218.

Next, the control unit of the image pickup apparatus 1 will be described. A system control unit 209, which serves as the control unit, controls the entire operation of the image pickup apparatus 1. A system memory 219 stores constants, variables, and programs used for the operation of the system control unit 209. A nonvolatile memory (NVM) 220 is an electrically erasable and recordable memory such as an EEPROM.

A shutter switch (SW1), a shutter switch (SW2), and an operation unit 221 are operation means for allowing a user to input a variety of operation instructions to the system control unit 209. A mode dial 222 is used by the user to switch the operation mode of the system control unit 209 among a still image capturing mode, a continuous shooting (or imaging) mode, a moving image capturing mode, a playback mode, and the like. The shutter switch (SW1) is turned on when a release button 223 provided on the image pickup apparatus 1 is half-pressed. The shutter switch (SW1) instructs the start of operations such as AF, AE, AWB, and EF. The shutter switch (SW2) is turned on when the release button 223 is fully pressed, instructing the start of a series of image pickup operations from reading signals from the imaging unit 203 to writing image data to the recording medium 215.

The operation unit 221 includes a variety of buttons and a touch panel. For example, it includes an erase button, a menu button, a set button, and a cross key (four-directional key). When the menu button is pressed, a menu screen for a variety of settings is displayed on the image display unit 217. The user can intuitively make a variety of settings using the menu screen displayed on the image display unit 217 together with the four-directional key and the set button. Alternatively, contact of a user's finger or pen with the image display unit 217 may be detected, and icons displayed thereon may be interpreted as equivalent to operations of physical buttons or dials. An operation member that can detect rotation, such as a jog dial, may be used to perform operations similar to those of the bidirectional key.

A power button 224 switches between powering on and powering off. A power control unit 225 includes a battery detecting circuit, a DC-DC converter, and a switching circuit for switching blocks to be electrified, and detects battery attachment, battery type, and remaining battery level. Based on the detection result and instruction from the system control unit 209, the power control unit 225 controls the DC-DC converter and supplies the required voltage to each component, including the recording medium 215, for a required period. A battery 226 may be a primary battery such as an alkaline or lithium battery, or a secondary battery such as a NiCd battery, a NiMH battery, or a lithium-ion battery, or may be an AC adapter. The battery 226 and the power control unit 225 are connected via a battery connector. An RTC (Real Time Clock) 227 maintains an internal power source separately from the power control unit 225 and continues timekeeping even when the battery 226 is removed or exhausted.

The system control unit 209 performs timer control using the date and time acquired from the RTC 227 at startup. A recording medium attachment/detachment detector (REC detector) 228 detects whether the recording medium 215 is inserted into a recording medium slot. A communication unit (COMM) 229 performs various communication processing such as RS-232C, USB, IEEE 1394, P1284, SCSI, modem, LAN, and wireless communication. External I/F cable connectors 136 to 139 connect the image pickup apparatus 1 to external devices through the communication unit 229. The system control unit 209 controls the driving (rotation, rotation stop, and number of rotations) of a fan 231 to dissipate heat.

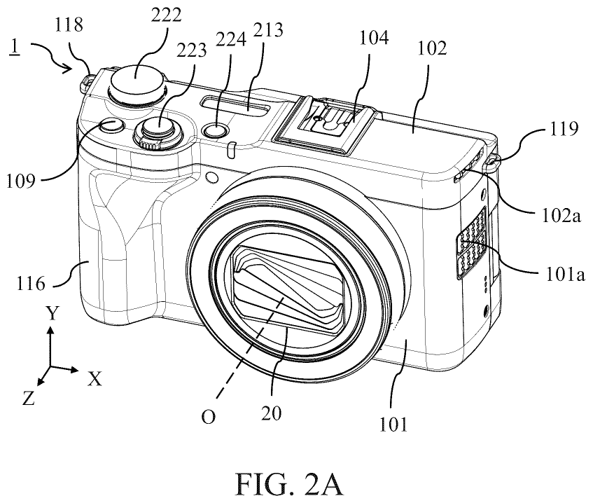

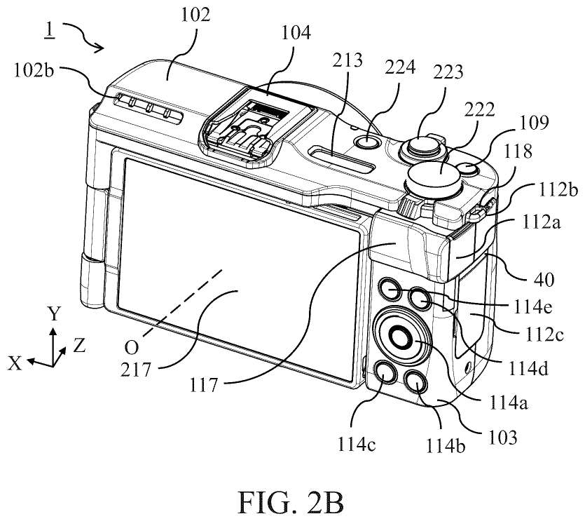

Referring now to FIGS. 2A and 2B, a description will be given of the external structure of the image pickup apparatus 1. FIGS. 2A and 2B are perspective views illustrating the external appearance of the image pickup apparatus 1. FIG. 2A illustrates the image pickup apparatus 1 viewed from the front side (object side), and FIG. 2B illustrates the image pickup apparatus 1 viewed from the rear side (image side). In FIGS. 2A and 2B, the direction parallel to the optical axis O of the image pickup apparatus 1 is defined as the Z-axis direction (Z direction, first direction), the vertical direction (height direction) of the image pickup apparatus 1 is defined as the Y-axis direction (Y direction, second direction), and the width direction (horizontal direction) of the image pickup apparatus 1 is defined as the X-axis direction (X direction, third direction). These XYZ axes are common among the figures in the following description.

The exterior of the image pickup apparatus 1 includes a front cover 101, a top cover 102, a rear cover 103, an I/F base 40, and terminal covers 112a, 112b, and 112c. The terminal covers 112a, 112b, and 112c cover, open, and close external I/F cable connectors (not illustrated) that can accommodate external interface cables.

Provided on the front side of the image pickup apparatus 1 are a lens barrel 20 and a grip portion 116. Provided on the upper surface of the image pickup apparatus 1 are a release button 223, a power button 224, a mode dial 222, a moving image capturing button 109, a microphone 213 for collecting external sound, and an accessory shoe 104. The lens barrel 20 may be integrated with or detachably attached to the image pickup apparatus 1. The imaging unit 203 including an image sensor such as a CMOS sensor is provided in the lens barrel 20 and collects light along the optical axis O.

An image display unit 217 including an LCD or the like is provided on the rear surface side of the image pickup apparatus 1. When viewing the image pickup apparatus 1 from the rear side, a plurality of operation buttons 114a to 114e and a grip portion 117 are provided to the right of the image display unit 217. The grip portion 117 is disposed on the rear surface of the image pickup apparatus 1 for the user to grip (more specifically, for the user's thumb to rest on) the image pickup apparatus 1.

By operating the operation buttons 114a to 114e, a captured image can be displayed on the image display unit 217 and a variety of settings can be configured. The user holds the image pickup apparatus 1 by grasping the grip portion 117 on the rear cover 103 with his right thumb and the grip portion 116 on the front cover 101 side with his other right fingers, and presses the release button 223 or the moving image capturing button 109 with his right index finger (to perform a capture operation). Thereby, the user can capture a still or moving image using the image pickup apparatus 1.

Provided on the side surfaces of the image pickup apparatus 1 are ear loops 118 and 119 for attaching camera accessories such as a neck strap (not illustrated). The image pickup apparatus 1 includes a fan, which will be described later, and the front cover 101 has an intake port 101a, which is an intake port for the fan, and the top cover 102 has exhaust ports 102a and 102b, which are exhaust ports for the fan.

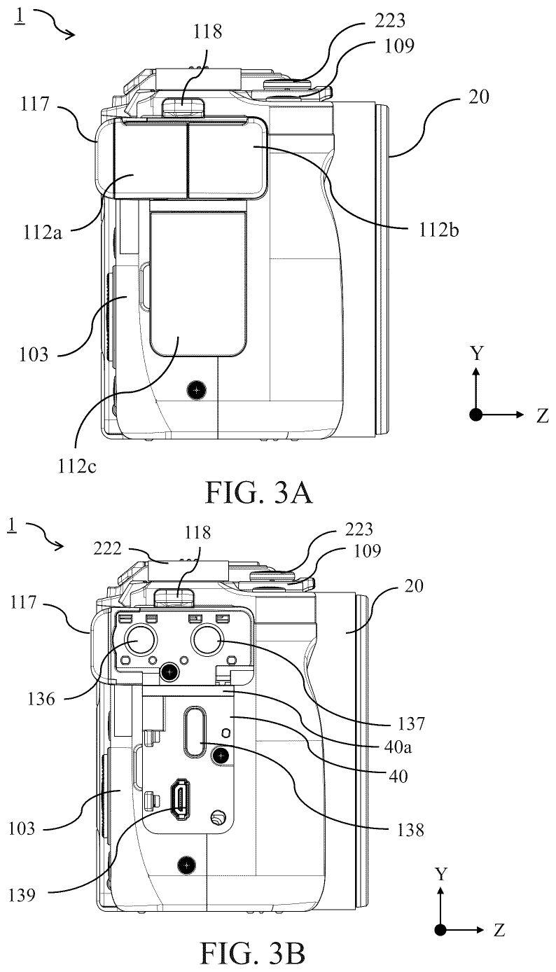

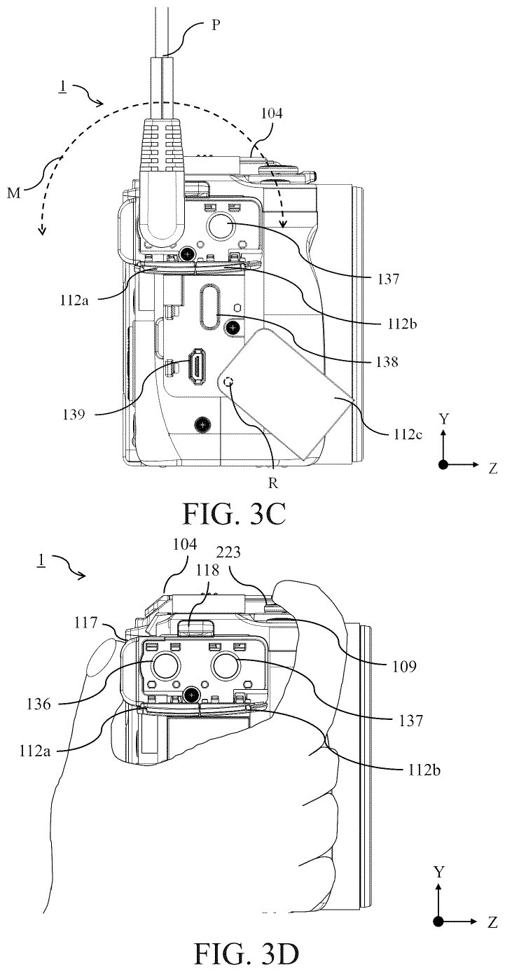

Referring now to FIGS. 3A, 3B, 3C, and 3D, a description will be given of the configuration around the external I/F cable connector. FIGS. 3A, 3B, 3C, and 3D are side views of the image pickup apparatus 1. FIG. 3A illustrates the image pickup apparatus 1 with the terminal covers 112a, 112b, and 112c closed. FIG. 3B illustrates the image pickup apparatus 1 with the terminal covers 112a, 112b, and 112c not illustrated. FIG. 3C illustrates the image pickup apparatus 1 with the terminal covers 112a, 112b, and 112c open. FIG. 3D illustrates the image pickup apparatus 1 being held by a user with the terminal covers 112a and 112b open.

As illustrated in FIG. 3B, the image pickup apparatus 1 has external I/F cable connectors 136, 137, 138, and 139 on the side surface (side surface on the-X side) of the image pickup apparatus 1, to which external I/F cables (cables for electrically connecting the image pickup apparatus 1 to an external device) can be attached. The external I/F cable connectors 136, 137, 138, and 139 function as a first connector, a second connector, a third connector, and a fourth connector, respectively, which can be electrically connected to an arbitrary external device via an external I/F cable.

The external I/F cable connector (first connector) 136 is a connector connectable to an audio input/output device and dedicated to audio input/output for inputting and outputting audio. The external I/F cable connector (second connector) 137 is a connector connectable to an audio input/output device and dedicated to audio input/output for inputting and outputting audio. The external I/F cable connector (third connector) 138 is a connector connectable to an external device other than the audio input/output device.

As illustrated in FIG. 3A, the image pickup apparatus 1 has terminal covers 112a, 112b, and 112c that cover, open, and close the external I/F cable connectors 136, 137, 138, and 139. The terminal cover 112a covers the external I/F cable connector 136. The terminal cover 112b covers the external I/F cable connector 137. The terminal cover 112c covers the external I/F cable connectors 138 and 139.

By opening each terminal cover as needed, the user can attach an external I/F cable to the external I/F cable connector exposed from an opening formed in the I/F base 40, as illustrated in FIG. 3B. Thus, in this embodiment, a plurality of external I/F cable connectors are disposed together on the grip portion side of image pickup apparatus 1.

As illustrated in FIG. 3B, the external I/F cable connectors 136 and 137 are aligned in the Z direction between operation units (imaging execution unit), such as release button 223 and moving image capturing button 109, and the grip portion 117 of the rear cover 103. Thus, the external I/F cable connectors 136 and 137 are disposed on the side surface on the side of the grip portion 117. For example, the external I/F cable connectors 136 and 137 are arranged on a straight line parallel to the optical axis on the side surface on the side of grip portion 117, and are closer to the operation unit than the external I/F cable connector 138.

The external I/F cable connectors 136 and 137 are arranged on the side surface of the image pickup apparatus 1 along a first direction (Z direction) parallel to the optical axis O, forming a first connector array (first array) A1. On the other hand, the external I/F cable connectors 138 and 139 are arranged below the external I/F cable connectors 136 and 137 along a second direction (Y direction) perpendicular to the first direction, forming a second connector array (second array) A2. The image pickup apparatus 1 according to this embodiment may include only one of the external I/F cable connectors 138 and 139.

In this embodiment, when viewed from the side surface of the image pickup apparatus 1, the external I/F cable connectors 136 and 137 are arranged on a line in the Z direction that passes through the grip portion 117. On the other hand, at least one of the external I/F cable connectors 138 and 139 is disposed on a line in the Z direction that does not pass through the grip portion 117. At least one of the external I/F cable connectors 138 and 139 may be disposed on the opposite side of the operation unit (release button 223 and moving image capturing button 109) with respect to the external I/F cable connectors 136 and 137 in the Y direction. At least one of the external I/F cable connectors 138 and 139 may be disposed between the external I/F cable connectors 136 and 137 in the Z direction.

The arrangement direction of the first connector array A1 is not limited to a structure that strictly coincides with the Z direction, but may be approximately aligned with the Z direction. For example, at least a part of the external I/F cable connectors 136 and 137 may be arranged on a line along the Z direction. Even if at least a part of the external I/F cable connectors 136 and 137 are not arranged on a line along the Z direction, the terminal covers 112a and 112b may be arranged along the Z direction. Similarly, the arrangement direction of the second connector array A2 is not limited to a structure that strictly coincides with the Y direction, but may be approximately aligned with the Y direction. For example, at least a part of the external I/F cable connectors 138 and 139 may be arranged on a line along the Y direction.

An area between the above operation unit (imaging execution unit) and the grip portion 117 of the rear cover 103 is a portion that requires a distance to some extent in the Z direction to secure a stable holding performance during imaging using the image pickup apparatus 1, even in an attempt to reduce the size of the image pickup apparatus 1. In this embodiment, the image pickup apparatus 1 makes effective use of this portion, and the external I/F cable connectors 136 and 137 are arranged side by side in the Z direction (first connector arrangement A1). On the other hand, an area below the imaging execution unit and the grip portion 117 of the rear cover 103 is a portion that may be made thinner in an attempt to reduce the size of the image pickup apparatus 1. In the image pickup apparatus 1 according to this embodiment, the external I/F cable connectors 138 and 139 are arranged side by side in the Y direction in this portion (second connector arrangement A2). Due to this structure, a plurality of external I/F cable connectors are grouped together on the grip portion side of the image pickup apparatus 1, without increasing the size of the image pickup apparatus 1. Therefore, this embodiment can provide the image pickup apparatus 1 that can have a reduced size and secure holding performance.

Next, the types and arrangement of external I/F cable connectors in the image pickup apparatus 1 according to this embodiment will be described. In the image pickup apparatus 1, the external I/F cable connectors 136 and 137 are audio phone jacks that support phone plugs such as 3.5 mm diameter mini plugs or 6.5 mm diameter standard plugs.

The external I/F cable connector 136 is an external microphone connector. The external I/F cable connector 137 is a headphone connector. The external I/F cable connector 138 is a connector that complies with the Universal Serial Bus (USB) Type C standard. The external I/F cable connector 139 is a connector that complies with the High-Definition Multimedia Interface (HDMI) (registered trademark) standard.

The image pickup apparatus 1 according to this embodiment includes an external microphone connector as the external I/F cable connector 136, and can acquire audio from an external microphone (not illustrated) attached to the accessory shoe 104, etc. The image pickup apparatus 1 also has a headphone connector as the external I/F cable connector 137, and can output audio acquired by the microphone 213 or an external microphone (not illustrated) from headphones (not illustrated) worn by the user. The image pickup apparatus 1 also has a USB Type-C connector as the external I/F cable connector 138, and can receive power from an external device that complies with the USB Power Delivery (USB PD) standard, allowing for long-term imaging. The image pickup apparatus 1 includes an HDMI connector as the external I/F cable connector 139, and can output video and audio captured by the image pickup apparatus 1 to a display device such as a display unit that complies with the HDMI standard.

Next, the terminal cover of the image pickup apparatus 1 according to this embodiment will be described. As illustrated in FIG. 3C, the terminal covers 112a and 112b, which cover the first connector array A1, are configured to open from the closed state illustrated in FIG. 3A towards the second connector array A2. The terminal cover 112c that covers the second connector array A2 is configured to open by rotating about a rotation axis R from the closed state illustrated in FIG. 3A.

The terminal covers 112a and 112b covering the first connector array A1 may open so as to retreat into space 40a of the I/F base 40 provided between the terminal covers 112a and 112b, and the terminal cover 112c. Thereby, in a case where the terminal cover 112c is openable while the terminal covers 112a and 112b are open, the plurality of terminal covers can be prevented from interfering with each other and becoming unable to open.

If the space 40a is not provided, the terminal covers may be made of an elastic material such as elastomer so that they can open by elastic deformation even if there is some interference between them. The terminal covers 112a and 112b can be separate or integrated.

Referring now to FIG. 3D, a description will be given of the reason why the terminal covers 112a and 112b covering the first connector array A1 are configured to open from the closed state illustrated in FIG. 3A towards the second connector array A2. As illustrated in FIG. 3D, when the terminal covers 112a and 112b are opened toward the second connector array A2, they can be accommodated into the space between the user's thumb, which is located on the grip portion 117 of the rear cover 103, and the index finger, which is located on the release button 223 or the moving image capturing button 109. Due to this structure, the user can grip the image pickup apparatus 1 and capture an image with an external I/F cable attached to the first connector array A1, while the terminal covers 112a and 112b covering the first connector array A1 do not hinder the user. Therefore, even if the structure is used in which the multiple external I/F cable connectors are closely disposed on the grip portion side, a compact structure can be achieved without compromising the operability of the image pickup apparatus 1.

If the terminal covers were to open and close in the forward and backward directions (Z direction) of the image pickup apparatus 1, they could interfere with the user's thumb or index finger, and it would become difficult to grip the image pickup apparatus 1. Furthermore, in a case where the terminal cover opens or closes toward the top cover 102, the release button 223, the moving image capturing button 109, the mode dial 222, etc., located on the top cover 102 may interfere with the open terminal cover. This could result in an unintended malfunction by the user.

In addition, in the image pickup apparatus 1 according to this embodiment, the ear loop 118 is located in the first connector array (A1). This configuration allows accessories such as a neck strap to be attached to the ear loop 118 at a position that is unlikely to be touched by the user's finger and that does not interfere with attaching a cable to the first connector array (A1). This allows the user to capture an image while stably holding the image pickup apparatus 1, even in a case where a neck strap is attached.

In addition, in the image pickup apparatus 1 according to this embodiment, as described above, an external microphone connector is located as the external I/F cable connector 136, and a headphone connector is located as the external I/F cable connector 137. They are connected to an external microphone (not illustrated) attached to the accessory shoe 104 or headphones (not illustrated) worn by the user, and therefore, as illustrated in FIG. 3C, the external I/F cable P is pulled out above the image pickup apparatus 1.

Thus, by opening the terminal covers 112a and 112b covering the first connector array A1 toward the second connector array A2, the terminal covers 112a and 112b do not hinder the external I/F cable heading toward the accessory shoe 104 or the user. Due to this structure, the user can hold the image pickup apparatus 1 and capture an image while the external I/F cable is attached to the first connector array A1, while the external I/F cable or terminal covers 112a and 112b connected to the first connector array A1 do not hinder the user.

As described above, the image pickup apparatus 1 according to this embodiment includes an external microphone connector as the external I/F cable connector 136 and a headphone connector as the external I/F cable connector 137. These are phone jacks. Therefore, as illustrated in FIG. 3C, the attached cable P can rotate in a direction indicated by a broken line M around the center of the phone jack hole. In FIG. 3C, an L-shaped plug is connected, in which the plug pin is oriented at an angle of 90° relative to a cable pull-out direction, and the I/F cable is pulled out above the image pickup apparatus 1 toward the accessory shoe 104 or the user.

Thereby, since the terminal covers 112a and 112b covering the first connector array A1 open toward the second connector array A2, the degree of wiring freedom can be increased when the cable is directed above the image pickup apparatus 1. The attached cable can be directed toward the accessory shoe 104 in the shortest distance and easily follow the movements of the user wearing the headphones. Furthermore, as illustrated in FIG. 3D, while the user holds the image pickup apparatus 1, the rotational position of the cable can be properly adjusted according to the position of the user's finger. Therefore, an image can be captured while the image pickup apparatus 1 can be stably held.

On the other hand, the USB Type-C connector and HDMI connector are connected in long-time imaging while power is received or in an attempt to output video and audio captured by the image pickup apparatus 1 to a display device such as a monitor. Thus, these connectors are rarely used while the user holds the image pickup apparatus 1. Accordingly, in the image pickup apparatus 1 according to this embodiment, the USB Type-C connector and HDMI connector are arranged in the second connector array A2. By arranging different-shaped connectors such as the USB Type-C connector and HDMI connector in the second connector array A2, connectors such as the above phone jack can be preferentially arranged in the first connector array A1. In a case where a different-shaped connector such as an RJ-45 terminal compatible with an Ethernet cable is installed, it may be disposed in the second connector array A2.

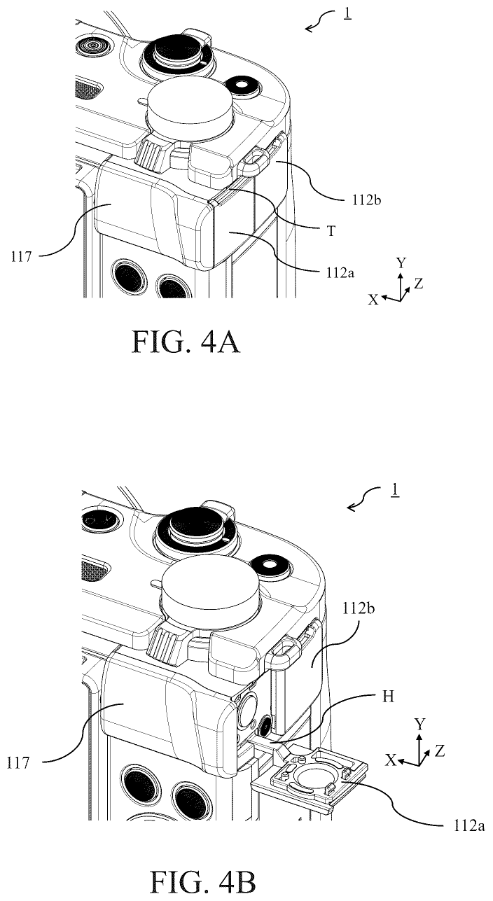

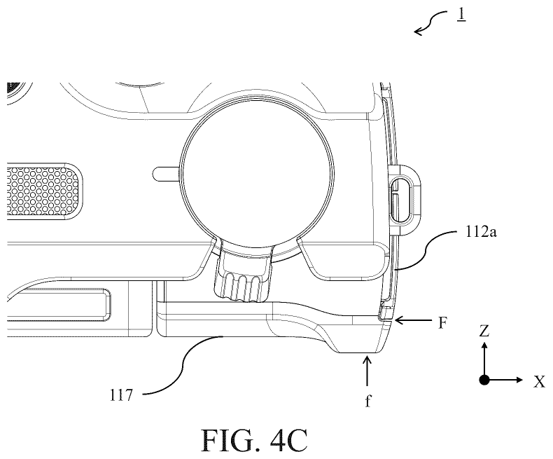

A description will now be given of the finger hook portion of the terminal cover in the image pickup apparatus 1 according to this embodiment. FIGS. 4A, 4B, and 4C are external views illustrating a part of the image pickup apparatus 1. FIG. 4A illustrates a part of the image pickup apparatus 1 with the terminal cover 112a closed. FIG. 4B illustrates a part of the image pickup apparatus 1 with the terminal cover 112a open. FIG. 4C is an external view illustrating a part of the image pickup apparatus 1 with the terminal cover 112a closed.

As illustrated in FIGS. 4A and 4B, the terminal cover 112a has a finger hook portion T for opening the terminal cover 112a. The finger hook portion T is located opposite to the external I/F cable connectors 138 and 139 with respect to the terminal cover 112a in the Y direction of the image pickup apparatus 1. By operating the finger hook portion T with the user's finger, the terminal cover 112a can be opened toward the second connector array A2. At this time, as illustrated in FIG. 4B, a flexible hinge portion H provided on the terminal cover 112a is pulled out of the image pickup apparatus 1, and the terminal cover 112a is stopped at a predetermined position by an unillustrated stopper. The terminal cover 112b is also configured similarly to the terminal cover 112a.

Referring to FIG. 4C, a boundary F between the grip portion 117 and the terminal cover 112a will be described. In the image pickup apparatus 1 according to this embodiment, the boundary F between the grip portion 117 and the terminal cover 112a is located on the side surface of the image pickup apparatus 1. Due to this structure, the terminal cover 112a will not be inadvertently opened by the thumb placed on the grip portion 117, and the user can capture an image while stably holding the image pickup apparatus 1. Therefore, even though multiple external I/F cable connectors are closely disposed on the grip portion side, a structure suitable for a compact body can be achieved without impairing the operability of the image pickup apparatus 1. On the other hand, in a case where the boundary F between the grip portion 117 and the terminal cover 112a is located on the rear surface side of the image pickup apparatus 1, like the position f in FIG. 4C, the thumb placed on the grip portion 117 may inadvertently touch the terminal cover 112a and cause the terminal cover 112a to open.

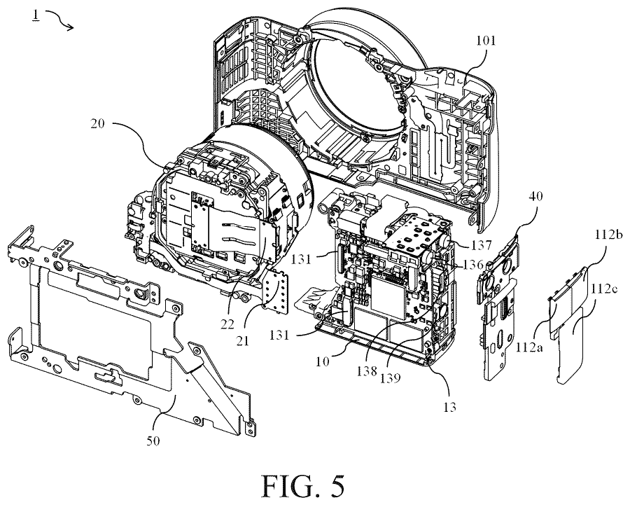

Referring now to FIG. 5, a description will be given of an overview of the component configuration of the image pickup apparatus 1. FIG. 5 is an exploded perspective view illustrating a part of the image pickup apparatus 1. This embodiment will omit the overall structure of the image pickup apparatus 1, and will discuss only the components necessary for this embodiment in detail.

The image pickup apparatus 1 is configured in which the lens barrel 20 and battery box unit 10 are arranged adjacent to each other between the front cover 101 and the chassis 50. The battery box unit 10 is located on the grip portion side of the image pickup apparatus 1.

The battery box unit 10 includes a control board 13. A connector 131 is mounted on the control board 13. Flexible printed circuits (boards) (FPC) 21 and 22 are previously assembled on the lens barrel 20. The control board 13 and lens barrel 20 are electrically connected by connecting the FPCs 21 and 22 to the connector 131.

The battery box unit 10 includes the external I/F (interface) cable connectors 136, 137, 138, and 139 to which the external I/F cables can be attached. The image pickup apparatus 1 includes the I/F base 40 disposed on the side surface of the housing, and the external I/F cable connectors 136, 137, 138, and 139 are exposed from openings formed in the I/F base 40. By opening the terminal covers 112a, 112b, and 112c as needed, the user can attach the external I/F cables (not illustrated) to the external I/F cable connectors 136, 137, 138, and 139 exposed from these openings.

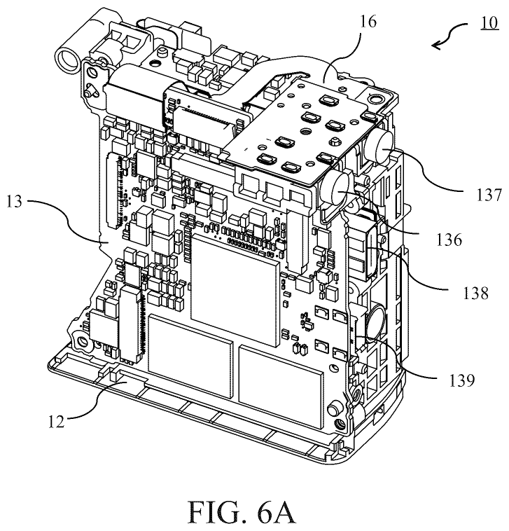

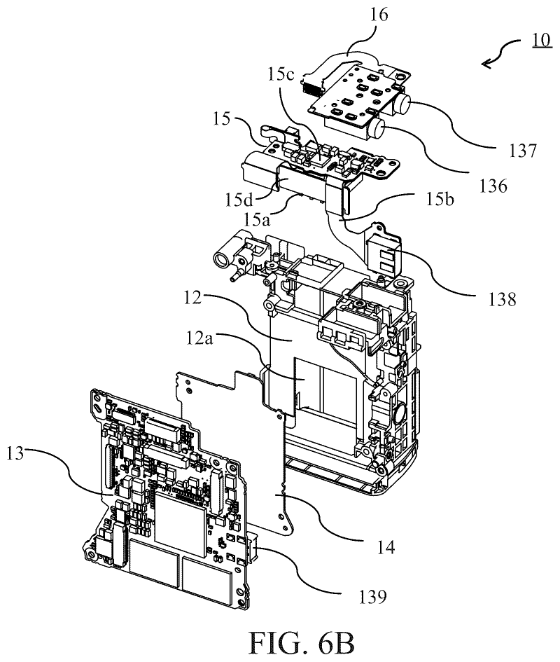

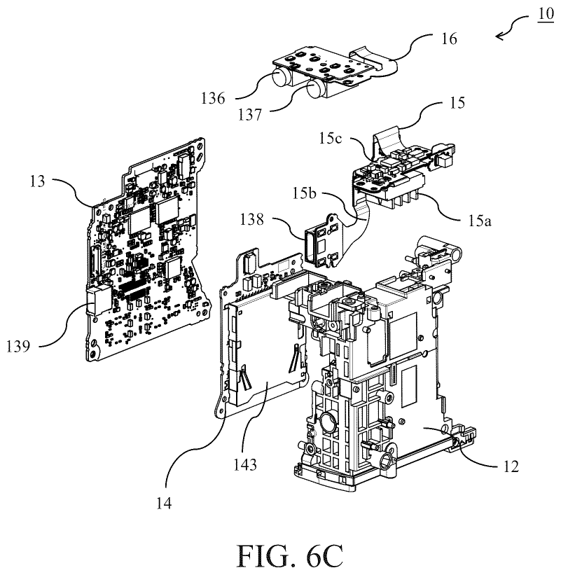

Next, the battery box unit 10 according to this embodiment will be described in detail with reference to FIGS. 6A, 6B, and 6C. FIGS. 6A, 6B, and 6C explain the battery box unit 10. FIG. 6A illustrates a perspective view of the battery box unit 10. FIG. 6B illustrates an exploded perspective view of the battery box unit 10 viewed from the rear side. FIG. 6C illustrates an exploded perspective view of the battery box unit 10 viewed from the front side.

The battery box unit 10 mainly includes a control board 13, a card media board 14, and a battery box 12. The battery box 12 has a battery chamber (accommodation portion) 12a that can accommodate a battery (not illustrated). The battery box unit 10 includes the control board 13, a rigid-flex printed wiring board 15, and an FPC 16. The control board 13 includes the external I/F cable connector 139. The rigid-flex printed wiring board 15 includes the external I/F cable connector 138. The external I/F cable connectors 136 and 137 are mounted on the FPC 16.

A battery connector 15a is mounted on the substrate 15d, which is the rigid portion of the rigid-flex printed wiring board 15. The battery connector 15a is electrically connectable to a battery terminal provided on the battery (not illustrated). A USB Type-C connector is mounted on the tip of an extension portion 15b as the flexible portion of the rigid-flex printed wiring board 15, and serves as the external I/F cable connector 138. A power charging/supplying circuit 15c is also mounted on the rigid-flex printed wiring board 15, and configured to charge and supply power between devices that comply with the USB PD standard. In this embodiment, the external I/F cable connector 138 is mounted on the extension portion 15b of the rigid-flex printed wiring board 15, and is used to supply power to the image pickup apparatus 1.

The control board 13 and card media board 14 are fixed to the battery box 12 with screws (not illustrated). After the control board 13 and card media board 14 are fixed to the battery box 12, the rigid-flex printed wiring board 15 and the FPC 16 are connected to the control board 13, and thereby the battery box unit 10 is completed.

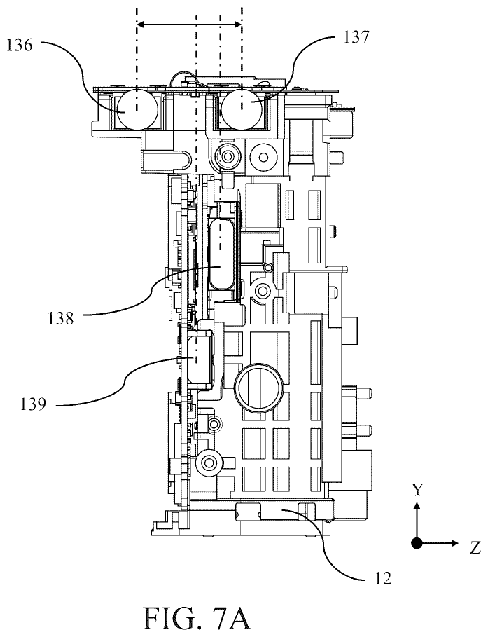

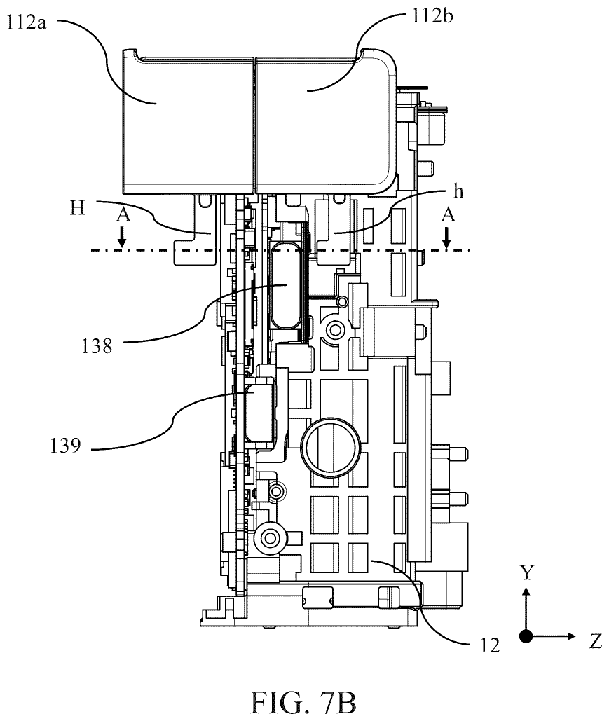

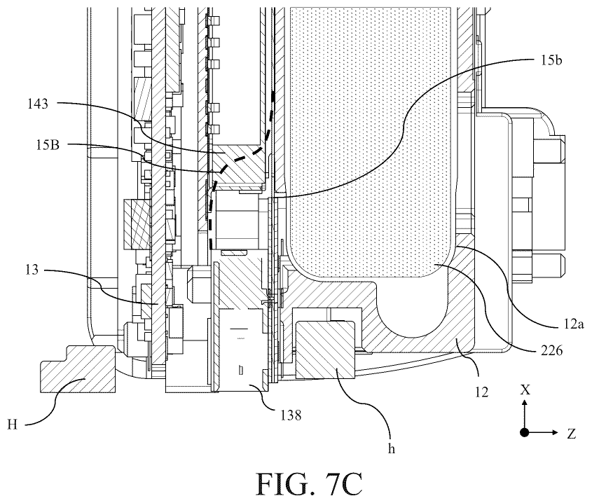

FIGS. 7A, 7B, and 7C explain the battery box unit 10. FIG. 7A illustrates a side view of the battery box unit 10. FIG. 7B is a side view of the battery box unit 10, illustrating the positions of the terminal covers 112a and 112b. FIG. 7C illustrates a cross-sectional view taken along a line A-A in FIG. 7B.

As illustrated in FIG. 7A, in the image pickup apparatus 1 according to this embodiment, the external I/F cable connectors 138 and 139 of the second connector array A2 are arranged in the Z direction between the external I/F cable connectors 136 and 137 of the first connector array A1. As illustrated in FIG. 7B, the flexible hinge portion H of the terminal cover 112a and the flexible hinge portion h of the terminal cover 112b are arranged to sandwich the external I/F cable connectors 138 and 139 of the second connector array A2 in the Z direction. This structure allows the external I/F cable connector 138 to be closer to the first connector array A1 in the Y direction, and thereby the height increase (width increase in the Y direction) of the image pickup apparatus 1 can be suppressed. This can also suppress the height increase in the Y direction of the image pickup apparatus 1, while also achieving a structure that allows the terminal covers 112a and 112b to be opened toward the second connector array A2.

As illustrated in FIG. 7C, the flexible hinge portion H of the terminal cover 112a and the flexible hinge portion h of the terminal cover 112b are arranged to sandwich the control board 13, on which the external I/F cable connector 139 is mounted, in the Z direction. This structure allows the outer shape of the control board 13 to be expanded in the-X direction. This can reduce the size of the image pickup apparatus 1 and maintain the maximum possible area for the control board 13.

The rigid-flex printed wiring board 15 is disposed while its extension 15b is aligned with the battery chamber 12a side, which houses the battery 226. Here, the USB Type-C connector is mounted so that it is on the opposite side of the battery 226 in the Z direction. In other words, the extension portion 15b is disposed between the battery 226 and the USB Type-C connector in the Z direction (the extension 15b is disposed between the battery chamber 12a and the external I/F cable connector 138 in the Z direction).

Thereby, a distance between the card connector 143 and the USB Type-C connector, which are adjacent in the X direction, can be reduced, and thereby the width of the image pickup apparatus 1 in the X direction can be suppressed. For example, if the mounting surface of the USB Type-C connector were reversed, the extension portion 15b would follow the path illustrated by dotted line 15B. In this case, it is necessary to eliminate interference between the card connector 143 and the extension portion 15b, which results in an increase in the size of the image pickup apparatus 1 in the −X direction. By positioning the USB Type-C connector at the top end of the second connector array A2, the extension portion 15b can be reduced, thereby achieving a structure suitable for reducing the size of the image pickup apparatus 1.

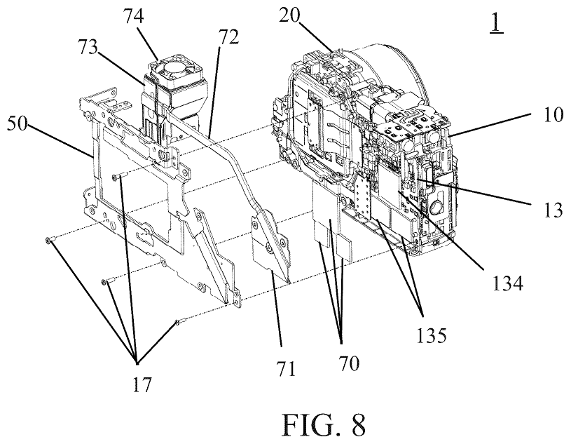

Referring now to FIG. 8, a description will be given of the heat dissipation structure (heat dissipation components) of the image pickup apparatus 1. FIG. 8 is a perspective view of the heat dissipation components of the image pickup apparatus 1. Large amounts of current flow through electronic components such as an image processing IC 134 and a memory 135 mounted on the control board 13 due to the image processing and memory control operations of the image pickup apparatus 1. As a result, heat is generated due to electrical resistance within these electronic components. In a case where the image pickup apparatus 1 continues to operate for a long period of time without any countermeasure against heat generated by the electronic components, the image pickup apparatus 1 may exceed its upper temperature limit for normal operation, resulting in a malfunction.

To deal with the heat generated by the image processing IC 134 or the memory 135, the image pickup apparatus 1 has a heat dissipation structure that combines multiple functional components. First, the image pickup apparatus 1 includes a heat dissipation sheet 70 that contacts the image processing IC 134 and the memory 135 and transfers heat toward the rear of the image pickup apparatus 1. The heat dissipation sheet 70 has a certain amount of elasticity and is sandwiched and fixed between a heat sink (or heat dissipation plate) 71 and the electronic components. The heat dissipation sheet 70 is a thermally conductive resin sheet formed by adding a highly thermally conductive filler to a resin sheet that has a certain amount of flexibility and is primarily made of acrylic or silicone resin.

The heat sink 71 is made of a metal with high thermal conductivity, such as copper or aluminum. The image pickup apparatus 1 further includes a heat pipe 72. One end of the heat pipe 72 is joined with and fixed by the heat sink 71. The other end of the heat pipe 72 is joined with and fixed by heat sink fins 73. A fan motor 74 is positioned adjacent to the heat sink fins 73. The fan motor 74 is controlled to dissipate heat and corresponds to the fan 231 in FIG. 1.

The heat pipe 72 is a thermally conductive element that transports heat, has a tubular shape with a capillary structure on the inner wall, and is made of a metal such as copper or aluminum. A small amount of working fluid is sealed inside the tube under reduced pressure. If the image processing IC 134 and the memory 135 generate heat and the heat dissipation sheet 70 transfers the heat to the heat sink 71 and one end of the heat pipe 72, the working fluid will easily evaporate due to the reduced pressure inside the tube. The evaporated working fluid will move as a vapor flow to the other end of the heat pipe 72, which is not heated. The vapor will then come into contact with the low-temperature inner wall of the tube and liquefy again. The working fluid, now back in liquid form, will travel along the capillary structure and return to the area where it is joined with the heat sink 71.

As the driving of the image pickup apparatus 1 continues and the image processing IC 134 and the memory 135 continue to generate heat, the working fluid will repeat the processes of evaporation, movement, and condensation to transport heat. The heat sink fins 73 are multiple metal fins that secure a large surface area to improve heat dissipation efficiency, and primarily made of metals such as copper or aluminum.

Several methods can be selected for the exterior shape of the heat sink fins 73. For example, they include die-casting, in which molten metal is poured into a mold and cast, welding and joining metal fins to a thin plate member, or bending a thin plate member at regular intervals to form continuous metal fins without welding.

The fan motor 74 receives a power supply and rotates blades fixed to the rotational shaft to perform its air blowing function. By placing the fan motor 74 adjacent to the heat sink fins 73 and driving it, it blows out heated air stagnating around the heat sink fins 73, reducing the deterioration in heat dissipation efficiency. The fan motor 74 can have a plurality of air blowing structures selected according to the rotational shaft and air blowing direction. For example, they include a propeller fan in which the intake and exhaust directions are aligned parallel to the rotation axis, or a blower fan (sirocco fan) in which the intake direction is parallel to the rotation axis and the exhaust duct is perpendicular to the intake direction.

The image pickup apparatus 1 uses the heat dissipation sheet 70, the heat sink 71, the heat pipe 72, the heat sink fins 73, and the fan motor 74 to form a heat dissipation structure for the electronic components that are heat sources, and is configured to make it less likely to stop operating even when the image pickup apparatus 1 operates for long periods of time. In this embodiment, the external I/F cable connectors 136, 137, and 138 are positioned on the opposite side of the fan motor 74 (fan 231) with respect to the optical axis O in the X direction.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide an image pickup apparatus that includes a plurality of external I/F cable connectors closely disposed on the grip portion side of the image pickup apparatus, and achieves a reduced size without impairing the operability of the image pickup apparatus.

This application claims the benefit of Japanese Patent Application No. 2024-227717, filed on Dec. 24, 2024, which is hereby incorporated by reference herein in its entirety.

What is claimed is:

1. An image pickup apparatus comprising:
a grip portion;
an operation unit configured to instruct imaging;
a first connector dedicated to audio input/output for inputting or outputting audio; and
a second connector dedicated to audio input/output for inputting or outputting audio,
wherein the first connector and the second connector are disposed on a side surface on a side of the grip portion.

2. The image pickup apparatus according to claim 1, further comprising a third connector connectable to an external device different from an audio input/output device,
wherein at least a part of each of the first connector and the second connector is disposed on a straight line parallel to an optical axis on the side surface on the side of the grip portion, and closer to the operation unit than the third connector.

3. The image pickup apparatus according to claim 1, further comprising a third connector connectable to an external device different from an audio input/output device,
wherein the first connector and the second connector are arranged side by side in a direction parallel to an optical axis on the side surface on the side of the grip portion, and closer to the operation unit than the third connector.

4. The image pickup apparatus according to claim 1, wherein the first connector is a microphone connector, and the second connector is a headphone connector.

5. The image pickup apparatus according to claim 2, wherein the third connector is a USB connector or an HDMI connector.

6. The image pickup apparatus according to claim 3, wherein the third connector is a USB connector or an HDMI connector.

7. The image pickup apparatus according to claim 1, wherein the operation unit includes at least one of a release button and a moving image capturing button.

8. The image pickup apparatus according to claim 2, further comprising a fourth connector electrically connectable to an external device,
wherein the third connector and the fourth connector are arranged in a direction perpendicularly intersecting an optical axis.

9. The image pickup apparatus according to claim 3, further comprising a fourth connector electrically connectable to an external device,
wherein the third connector and the fourth connector are arranged in a direction perpendicularly intersecting an optical axis.

10. The image pickup apparatus according to claim 2, wherein the third connector is disposed between the first connector and the second connector in a direction parallel to the optical axis.

11. The image pickup apparatus according to claim 3, wherein the third connector is disposed between the first connector and the second connector in a direction parallel to the optical axis.

12. The image pickup apparatus according to claim 2, further comprising a cover configured to cover the first connector, and open toward the third connector.

13. The image pickup apparatus according to claim 3, further comprising a cover configured to cover the first connector, and open toward the third connector.

14. The image pickup apparatus according to claim 12, further comprising a finger hook portion for opening the cover,
wherein the finger hook portion is disposed opposite to the third connector with respect to the cover in a direction perpendicularly intersecting an optical axis.

15. The image pickup apparatus according to claim 13, further comprising a finger hook portion for opening the cover,
wherein the finger hook portion is disposed opposite to the third connector with respect to the cover in a direction perpendicularly intersecting an optical axis.

16. The image pickup apparatus according to claim 2, further comprising:
a battery connector electrically connectable to a battery; and
a substrate on which the battery connector is mounted,
wherein the third connector is mounted on an extension portion of the substrate, and is used for supplying power to the image pickup apparatus, and
wherein the extension portion is disposed, in a direction parallel to the optical axis, between an accommodation portion that accommodates the battery and the third connector.

17. The image pickup apparatus according to claim 3, further comprising:
a battery connector electrically connectable to a battery; and
a substrate on which the battery connector is mounted,
wherein the third connector is mounted on an extension portion of the substrate, and is used for supplying power to the image pickup apparatus, and
wherein the extension portion is disposed, in a direction parallel to the optical axis, between an accommodation portion that accommodates the battery and the third connector.

18. The image pickup apparatus according to claim 1, further comprising a fan configured to dissipate heat, and disposed opposite to the grip portion with respect to a lens barrel.

19. The image pickup apparatus according to claim 1, further comprising:
a first cover configured to cover the first connector; and
a second cover configured to cover the second connector,
wherein at least a part of each of the first cover and the second cover is disposed on a straight line parallel to an optical axis.

20. The image pickup apparatus according to claim 19, wherein when a thumb is placed on the grip portion formed on a rear cover and an index finger is placed on the operation unit, the first cover and the second cover accommodated between the thumb and the index finger.
